(19) United States
(12) Patent Application Publication
(10) Pub. No.: US 2017/0232817 A1
(43) Pub. Date: Aug. 17, 2017

(54) AIR CONDITIONING SYSTEM FOR TRACTOR TRAILERS

(71) Applicant: David Hutchison, Highland, UT (US)

(72) Inventor: David Hutchison, Highland, UT (US)

(21) Appl. No.: 15/373,274

(22) Filed: Dec. 8, 2016

Related U.S. Application Data
(63) Continuation-in-part of application No. 14/789,874, filed on Jul. 1, 2015.
(60) Provisional application No. 62/019,730, filed on Jul. 1, 2014.
(60) Provisional application No. 62/055,282, filed on Sep. 25, 2014.

(51) Int. Cl. B60H 1/00; B60H 1/22; B60H 1/32

(52) U.S. Cl. CPC B60H 1/00378; B60H 1/3226; B60H 1/2225; B60H 1/323

(57) ABSTRACT

A system is disclosed for conducting energy from a refrigeration trailer to a truck for controlling temperature in the truck. The system comprises a refrigeration unit coupled to the trailer for cooling a first chamber of the trailer. The refrigeration unit has a first heat exchanger configured to cool a fluid. A second heat exchanger is disposed in a second chamber and is in fluid communication with the first heat exchanger in a coolant loop. An air moving device in the second chamber is operable to convey cold air from about the second heat exchanger to cool the second chamber (e.g., a truck cabin). A heater can provide heat for conveying into the second chamber. A power source in the refrigeration unit can power the air moving device and the heater, and other electronic devices associated with the truck. Associated methods are provided.

### RELATED APPLICATION(s)

This application is a continuation-in-part of U.S. patent application Ser. No. 14/789,874, filed on Jul. 1, 2015, which claims the benefit of U.S. Provisional Patent Application No. 62/019,730 filed on Jul. 1, 2014 and U.S. Provisional Patent Application No. 62/055,282 filed on Sep. 25, 2014, which are each incorporated herein by reference.

### BACKGROUND

Rest stops are generally required during long-haul trips using semi-tractor trailers. Both physical limitations of the driver and various laws can limit the number of hours that a driver can drive on the road. Depending on weather conditions, comfort of the driver during such rest stops can require air-conditioning. Furthermore, truck drivers can be required to rest and sleep 10 hours daily. In order to maintain comfortable conditions while the driver rests and the truck is stopped, the primary tractor engine can be idled or an alternative power unit can be used to power a cooling unit. Some options for powering air-conditioning units (and/or cabin heaters) include idling and dedicated power units such as diesel generators and alternative power units (APU). APUs can require a separate motor, condenser, evaporator, and fan to cool or heat the sleeping compartment. Specifications for trucks and APU's can vary; however, they can often utilize 200 CFM or more at 36° F. in order to provide adequate cooling. Idling can consume significant amounts of fuel, which increases overall trip costs, and can introduce excessive wear on diesel engines which are not designed to idle for extended periods of time. Thus, attempts at conditioning a cabin or sleeper unit that utilize the tractor air-conditioning system or a refrigerator unit on a refrigerated trailer have been explored. While some attempts to draw conditioned air from refrigerated trailers units have been made, the attempts thus far have presented unique difficulties which have prevented widespread adoption.

### SUMMARY

Accordingly invention embodiments herein provide a cold air diverter system. The cold air diverter system comprises an air intake, a cold air outlet, a first chamber, a fluid moving device, a second chamber, and a duct. The air intake can receive cold air discharged from the cold air outlet to cool the first chamber. The duct can fluidly couple the air intake to the fluid moving device that can be disposed at least in part in the second chamber. The fluid moving device can be operable to convey cold air from the first chamber to the second chamber through the duct.

In one embodiment, the first chamber comprises a refrigeration unit on a refrigeration trailer, the cold air outlet comprises an outlet of a refrigeration unit, and the second chamber comprises the cabin or sleeping unit of a semi-truck.

Also presented herein, is a method of cooling a semi-truck cabin or sleeping unit wherein the method includes diverting cold air from a refrigerator unit on a refrigeration trailer via an air intake to receive cold air discharged from a cold air outlet on the refrigerator unit to the cabin or sleeping unit on the semi-truck via a duct and a fluid moving device, and operating the fluid moving device to pull or draw cold air from the refrigerator unit through the duct and into the cabin or sleeping unit. This system also has strong environmental benefits through eliminating excess greenhouse emissions during engine shutdown rest periods.

Accordingly invention embodiments herein provide a system for conducting energy from a refrigeration trailer to a tractor. The system can comprise a refrigeration unit configured to cool a first chamber and having a first heat exchanger configured to cool a fluid. A second heat exchanger can be disposed in a second chamber and being in fluid communication with a coolant loop with the first heat exchanger. An air moving device can be disposed at least in part in the second chamber. The air moving device is operable to convey cold air from about the second heat exchanger to cool the second chamber. A heater can also be disposed in the second chamber for heating the second chamber via the air moving device. A power supply line can be coupled from a power source of the air conditioning unit to the air moving device, the heater, and/or at least one electronic device.

Also presented herein is a method of conducting energy from a refrigeration trailer to a truck cabin. The method can comprise cooling a fluid about a first heat exchanger of a refrigeration unit on a refrigeration trailer, and delivering the fluid to a second heat exchanger disposed in or about a cabin of a truck coupleable to the trailer. The method can comprise operating an air moving device to convey cold air from about the second heat exchanger to cool the cabin. The method can also comprise delivering power from the refrigeration unit via an electrical supply line to the truck for powering electronic devices associated with the truck.

There has thus been outlined, rather broadly, the more important features of the invention so that the detailed description that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

Features and advantages of the invention will be apparent from the detailed description that follows, and which taken in conjunction with the accompanying drawings, together illustrate features of the invention. It is understood that these drawings merely depict exemplary embodiments and are not, therefore, to be considered limiting of its scope. Furthermore, it will be readily appreciated that the components, as generally described and illustrated in the figures herein, could be arranged in a wide variety of configurations.

FIG. 1 is a schematic illustrating a partial cutaway view of a cold air diverter system in accordance with an example of the present disclosure.

FIG. 2 is schematic illustrating an air intake of a cold air diverter system associated with a refrigeration unit outlet in accordance with an example of the present disclosure.

FIG. 3 is a schematic illustrating a top open perspective view of an enclosure for a fluid moving device and a filter of a cold air diverter system in accordance with an example of the present disclosure.

FIG. 4 is a schematic illustrating a cross-section of a double wall supply and return air duct of a cold air diverter system in accordance with an example of the present disclosure.

FIG. 5A is a schematic illustrating a double wall supply and return air duct end fitting of a cold air diverter system in accordance with an example of the present disclosure.

FIG. 5B is a schematic illustrating a second view of a double wall supply and return air duct end fitting of a cold air diverter system in accordance with an example of the present disclosure.

FIG. 6 is a schematic illustrating a partial cutaway view of conducting energy from a trailer to a truck in accordance with an example of the present disclosure.

FIG. 7 is a schematic illustrating a top open perspective view of an enclosure for a fluid moving device to control temperature in a truck in accordance with an example of the present disclosure.

These drawings are provided to illustrate various aspects of the invention and are not intended to be limiting of the scope in terms of dimensions, materials, configurations, arrangements or proportions unless otherwise limited by the claims.

### DETAILED DESCRIPTION

Reference will now be made to exemplary invention embodiments and specific language will be used herein to describe the same. It will nevertheless be understood that no limitation in scope is thereby intended. Alterations and further modifications of inventive features described herein, and additional applications of inventive principles which would occur to one skilled in the relevant art having possession of this disclosure, are to be considered as inventive subject matter. Further before particular embodiments are disclosed and described, it is to be understood that this disclosure is not limited to the particular process and materials disclosed herein as such may vary to some degree. It is also to be understood that the terminology used herein is used for the purpose of describing particular embodiments only and is not intended to be limiting.

Definitions

In describing and claiming the present invention, the following terminology will be used.

The singular forms “a,” “an,” and “the” include plural referents unless the context clearly dictates otherwise. Thus, for example, reference to “a baffle” includes reference to one or more of such materials and reference to “diverting” refers to one or more such steps.

As used herein, the term “about” refers to a degree of deviation based on experimental error typical for the particular property identified. The latitude provided the term “about” will depend on the specific context and particular property and can be readily discerned by those skilled in the art. When used in connection with a numerical value, the term “about” is used to provide flexibility and allow the given value to be “a little above” or “a little below” the specific number stated. Further, unless otherwise stated, the term “about” shall expressly include “exactly,” consistent with the discussion below regarding ranges and numerical data.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

In this disclosure, “comprises,” “comprising,” “comprised,” “containing,” “having,” and the like can have the meaning ascribed to them in U.S. Patent law and can mean “includes,” “including,” and the like, and are generally interpreted to be open ended terms. The term “consisting of” is a closed term, and includes only the methods, compositions, components, systems, steps, or the like specifically listed, and that which is in accordance with U.S. Patent law. “Consisting essentially of” or “consists essentially” or the like, when applied to devices, methods, compositions, components, structures, steps, or the like encompassed by the present disclosure, refer to elements like those disclosed herein, but which may contain additional structural groups, composition components, method steps, etc. Such additional devices, methods, compositions, components, structures, steps, or the like, etc., however, do not materially affect the basic and novel characteristic(s) of the devices, compositions, methods, etc., compared to those of the corresponding devices, compositions, methods, etc., disclosed herein. In further detail, “consisting essentially of” or “consists essentially” or the like, when applied to the methods, compositions, components, systems, steps, or the like encompassed by the present disclosure have the meaning ascribed in U.S. Patent law and is open-ended, allowing for the presence of more than that which is recited so long as basic or novel characteristics of that which is recited is not changed by the presence of more than that which is recited, but excludes prior art embodiments. In this specification when using an open ended term, like “comprising” or “including,” it is understood that direct support should be afforded also to “consisting essentially of” language as well as “consisting of” language as if stated explicitly and vice versa. Each term provides support for the others as if expressly stated.

As used herein, “long haul tractor trailer” refers to a tractor and semi-truck trailer combination that is used to carry cargo nationally and/or cross-country. Long haul tractor trailers are generally used to deliver cargo over long distances while including a cabin area or sleeper compartment to allow the operator to sleep or rest as needed.

As used herein, “refrigeration unit,” “reefer,” or “reefer unit” refer to a refrigeration system used to maintain cold air temperatures in a cargo area of a trailer. The refrigeration unit can typically be a self-powered refrigeration unit independent of the tractor engine.

As used herein, “sleeper” or “sleeping unit” refers to a sleeping compartment of a cabin or truck cab. The sleeping compartment can be mounted behind the truck cab, attached to the cab, or incorporated as a part of the cab.

As used herein with respect to an identified property or circumstance, “substantially” refers to a degree of deviation that is sufficiently small so as to not measurably detract from the identified property or circumstance. The exact degree of deviation allowable may in some cases depend on the specific context. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Air Conditioning System for Tractor Trailers

In one embodiment herein, there is provided a cold air diverter system. The cold air diverter system can comprise an air intake, a cold air outlet, a fluid moving device, and a duct. The system can be designed such that the air intake receives cold air discharged from a cold air outlet in a first chamber. The duct can be fluidly coupled to the air intake and the fluid moving device. The fluid moving device can be operable to convey the cold air from the first chamber to the second chamber via the duct to cool a second chamber. In one embodiment, the fluid moving device is disposed at least in part within the second chamber.

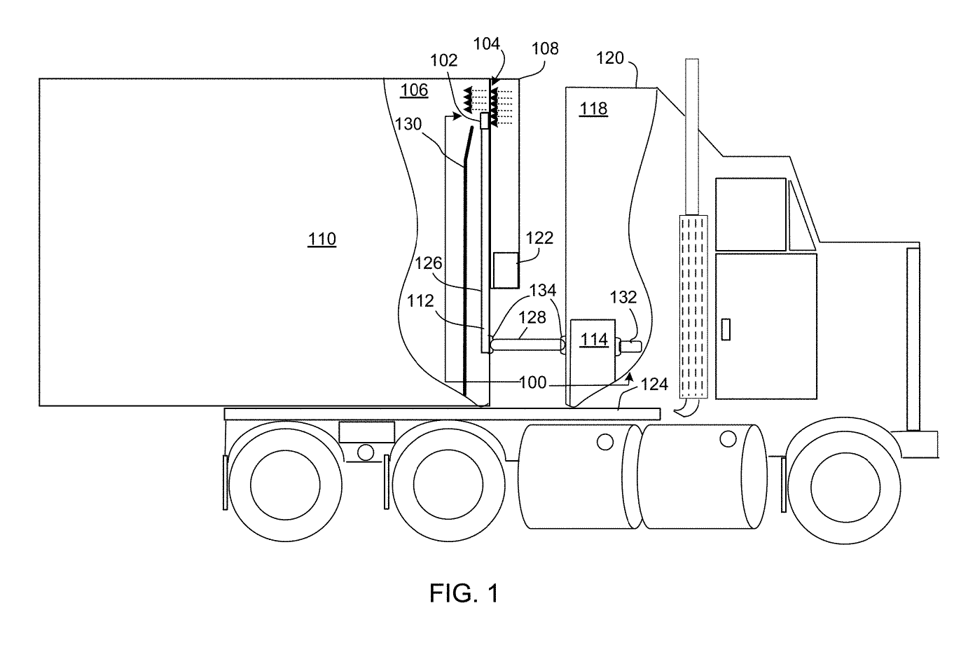

FIG. 1 is a schematic illustration of a cold air diverter system in accordance with one embodiment of the present disclosure. The cold air diverter system 100 can include an air intake 102 that is capable to receive cold air discharged from a cold air outlet 104 configured to cool a first chamber 106 such as from a refrigeration unit 108 (i.e. reefer) oriented at a forward wall of a “refrigeration trailer” 110. The cold air diverter system can be retrofitted to existing refrigeration units by orienting the air intake adjacent the cold air discharge within the trailer compartment. However, in some cases, the cold air diverter can be integrated into the refrigeration unit as a secondary cool air outlet.

The system can also include a fluid moving device 114, such as a pump or fan, to be disposed in a second chamber, such as in a cabin of a truck. The duct 112 can fluidly couple the air intake 102 and the fluid moving device 114. The fluid moving device can be operable to convey the cold air from the first chamber 116 to the second chamber 118 via the duct 112 to cool the second chamber. Thus, in one aspect, the system can be adapted to cool the cabin 120 of the truck using cool or cold air from the refrigeration unit 108.

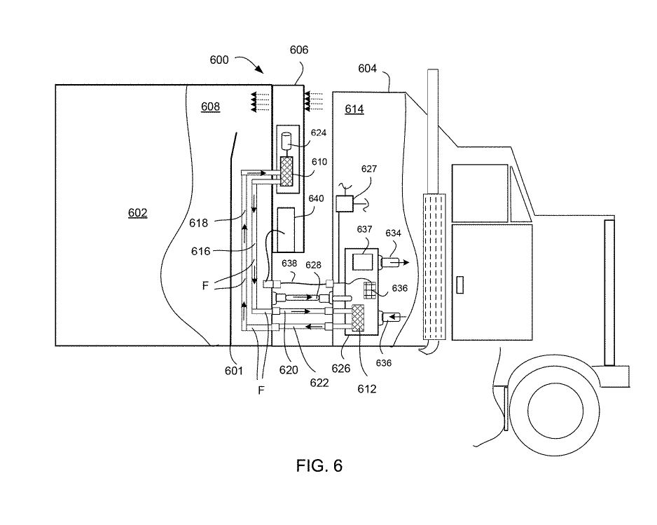

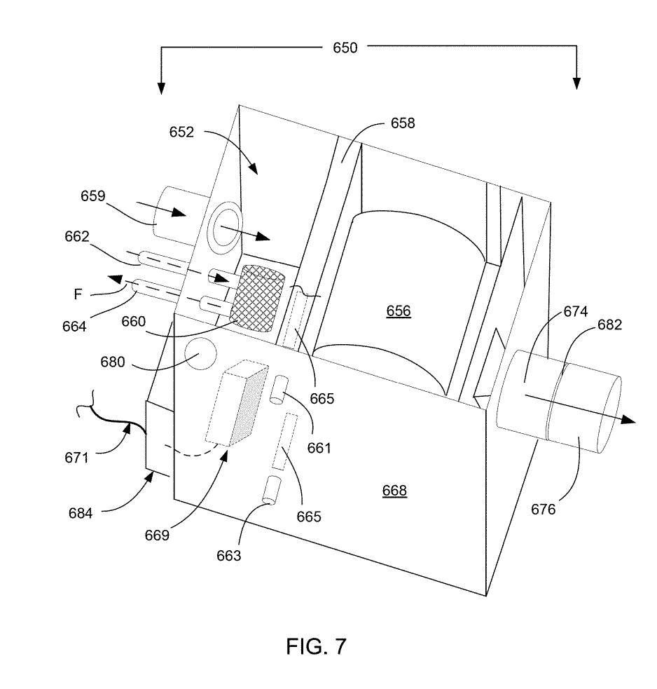

In a particular aspect, the fluid moving device can “suck” or “pull” air out of the refrigeration unit and direct that air into the cabin or sleeper of a truck. The fluid moving device can be oriented in the first chamber, the second chamber, or in between the second chamber, i.e. anywhere along a diversion path from the refrigeration unit to the cabin and/or sleeper. In one particular embodiment, the fluid moving device 114 can be oriented on the tractor unit 124, and in some cases placed within the cabin or sleeper unit (shown in FIG. 1 as the second chamber 118). In one embodiment, the fluid moving device can be configured to receive power from a power unit 122 of the refrigeration unit 108. Since the refrigeration unit can be operational to keep a perishable load refrigerated, the system can eliminate the need to run or “idle” the truck's engine in order to run the truck's cabin air conditioner for cooling while the truck is parked. For one example of such configuration, see the below discussion of FIGS. 6 and 7.

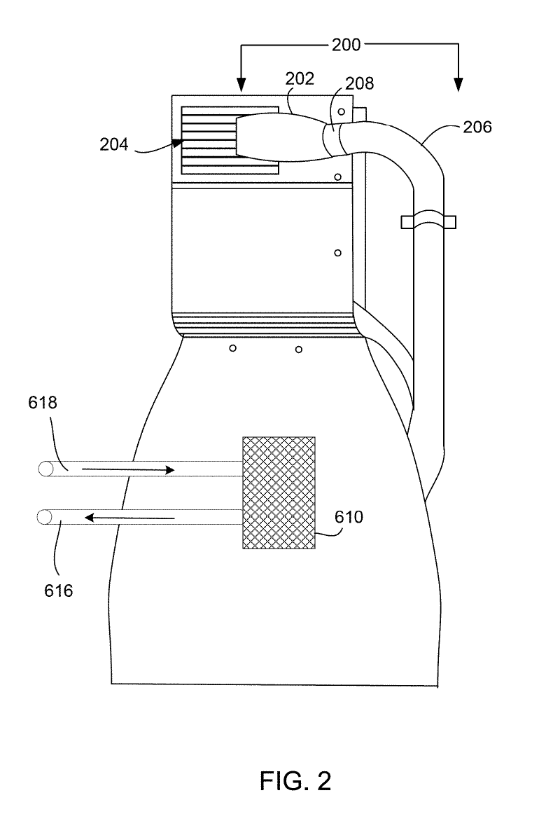

An air intake of a cold air diverter system is schematically shown in FIG. 2. The air intake 200 can comprise an air scoop 202. The air intake can cover a portion of the cold air outlet 204 to collect and direct cold air into the duct 206. In one aspect, this collecting of air directly from the cold air outlet provided by the refrigeration unit can contribute to the volumetric flow rate of air into the cabin, thus aiding the fluid moving device in moving air into the cabin. In another aspect, an adjustable baffle 208 can be associated with the air intake to allow or restrict airflow through the duct 206 according to cooling needs in the truck. The baffle can be controlled by a thermostat or manually controlled by the operator. Thus, when cooling is not needed in the cabin from the reefer, no cooling capacity is removed from the trailer. This can be of benefit when the truck is driven during the daytime in the summer when the cabin is cooled by cabin AC running off a compressor associated with the tractor engine, and the refrigeration unit can be operated to cool the refrigeration trailer without also cooling the cabin. At night, when the outside temperature is lower, the demand on the refrigeration unit is less and cooling capacity from the refrigeration unit can be diverted to the cabin to cool the cabin without using the native cabin AC, thus eliminating the need to run the truck's engine or auxiliary power to cool the cabin.

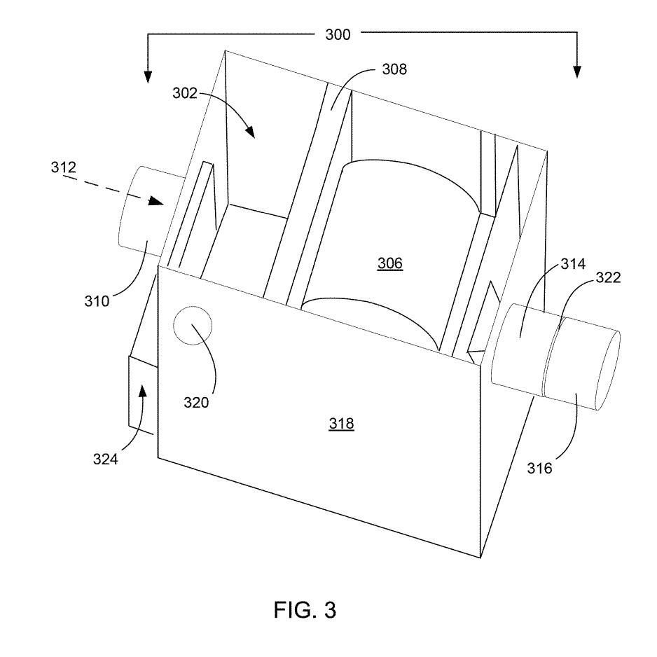

In one aspect, as shown in FIG. 3, the fluid moving device 300 can comprise an inlet chamber 302, a blower 306, and an air filter 308 oriented within an enclosure 318. The fan size, blower capacity and compartments can vary based on the designers and cabin size.

The air filter 308 can be oriented up stream of the blower 306 and can be used to remove particulates, prevent allergens in the air from entering the cabin, remove odors from the air, and/or to add fragrance to the air. In one embodiment, the air filter can be a carbon filter although fibrous air matte filters can also be used.

Air flow 312 can be directed into the fluid moving device 300 via a second inlet duct portion 310. Air flow through the fluid moving device can be unidirectional passing into the inlet chamber 302, through the filter 308, and then into the blower 306 before entering the second chamber. In another aspect airflow can be multidirectional, allowing air to be removed from the second chamber. The fluid moving device can include a transition feature 314 to convey air from the fluid moving device to an outlet/third ducting 316. In one embodiment, the transition feature can be a transition cube. The transition feature can be adapted to accommodate various ducting sizes, such as a 2″, 4″, 6″ or 8″ round connection. The transition feature can be connected a third duct portion 316 that can extend from the enclosure 318 of the fluid moving device and into or through the second chamber. In another embodiment, the transition feature and third duct portion can be used to directly tie the fluid moving device to the cabin duct work (not shown) existing in the cabin/sleeper unit via a coupling unit (not shown). In yet another embodiment, the third duct portion can be left unsecured within the cabin/sleeper unit along a flexible duct which is movable such that it can be placed or moved within the cabin.

In one embodiment the enclosure 318 surrounding the fluid moving device can be configured to be disposed inside the cabin or sleeper unit of the truck. In another embodiment, the fluid moving device can be configured in a protective casing that can be disposed exterior of the truck cabin and/or sleeper. The enclosure can also be provided with a fastening feature adapted to secure the enclosure to a surface within or on the truck body. For example, tabs, latches, holes or other features can be used to fasten the enclosure to a floor, wall or other fixed feature of the truck. In one specific embodiment the fastening feature can be a mounting bracket to attach with the fluid moving device.

In one aspect, the enclosure 318 can include an opening to receive ambient air from outside of the first and second chambers. The ambient air can either be used alone or in combination with the cool air from the refrigeration unit to provide a desired temperature inside the second chamber. In one embodiment, the enclosure can include a thermostat or thermostat relay 320 that is operable to allow the user to control the temperature within the second chamber. The thermostat can be programmable. In another embodiment, the thermostat can be operable by remote. In yet another embodiment, the thermostat can include a shut off valve that shuts off and/or turns on the fluid moving device respectively when the desired temperature range is reached or the temperature in the second chamber falls outside of a desired temperature range. In another aspect, the thermostat can control operation of one or more baffles 322 that can block airflow through the duct. Thus, the baffle can prevent cold air from reaching the cabin due to pressure from inside the trailer. In one aspect, the baffle can be associated with a duct connection and can be configured to automatically close upon separation of the duct connection and to open when the duct is connected.

In one aspect, the fluid moving device 300 can have multiple speeds to provide a suitable volume of airflow to the truck cabin. In another aspect, the fluid moving device can be configured to substantially match the output of the existing native cooling system of the second chamber. In one embodiment, this output can be about 250 cubic feet per minute (CFM). In yet other aspects the cooling system can be configured to run at about 100 CFM, about 200 CFM, about 300 CFM, about 400 CFM, about 500 CFM, about 600 CFM, about 700 CFM, about 800 CFM, about 900 CFM, or even about 1,000 CFM. The variable output can be based on the fan or blower size and/or a combination thereof. In another aspect this can be accomplished by using a fluid moving device that has the capacity to provide a suitable volumetric flow rates and accommodate losses due to the ducting and/or connections.

In one aspect, the fluid moving device 318 can include a power source 324 that can be used to power the blower. The power source can be located within the enclosure 318 or exterior to the enclosure. In one aspect, powered components of the system, such as the fluid moving device and thermostat, can be configured to receive power from the refrigeration unit, which can obviate the need to use truck power or batteries. Suitable electrical cables or wiring can be included to provide a power connection between the power unit 122 to the fluid moving device 114 or use existing electrical connections. For example, a jumper between the cabin and the trailer can be used to provide power from the refrigerator unit to the fluid moving device. The jumper can be removably coupled via quick connects or any other suitable removable coupling. In another aspect, the refrigeration unit can also be used to supply power to the cabin or sleeping unit for any other suitable purpose, such as to power appliances, electronics, etc. The system can therefore include any suitable power outlet or coupling feature to facilitate powering auxiliary or miscellaneous items. Accordingly, the refrigeration unit can include an alternator and/or a battery that provides power that can accommodate the refrigeration needs of the trailer, the fluid moving device, and/or any other suitable device that may be powered in the cabin. In other aspects, power can be provided external to the trailer and the cabin to power any suitable device outside the truck and trailer. In another embodiment, the power source can be an electrical outlet. In another embodiment, the power source can be a gas line. In a yet another embodiment, the power source can be a chargeable battery device.

The duct can include, as shown in FIG. 1, a first duct portion 126 extending between the air intake and a front wall of the first chamber, a second duct portion 128 extending between the wall of the first chamber and a wall of the second chamber, and/or a third duct portion 132 extending out from the fluid moving device 114. Thus, the second duct portion can extend between the trailer and the tractor unit. Notably, each duct can be provided as a single continuous duct or as multiple segments which are coupled to one another to form a longer duct unit. In one aspect, the second duct portion can be removably attachable to the wall of the first chamber and/or the wall of the second chamber and/or in the middle of the second duct via a coupling unit 134 or feature to facilitate disconnecting duct portions when detaching or switching trailers. The second duct portion can be connected between the truck and another trailer equipped with appropriate ducting, etc. as disclosed herein to cool the cabin of the truck. The duct can comprise a hose or any other suitable type of ducting to convey air between the trailer and the truck. Any suitable hose connection or quick-connect can be used to facilitate connection and disconnection of duct portions as desired. For example, quick-connect couplers can be associated with the trailer and the truck to removably connect with ducting extending between the trailer and the truck. In one aspect, the ducting and connections can be configured to minimize resistance to airflow to maximize effectiveness of the fluid moving device.

In one aspect, the system can also include a protective structure 130 (shown in FIG. 1) configured to protect the duct, duct connections, power cables, etc. from damage inside the first chamber or trailer. For example, the protective structure can provide a bulk head at a distance from a front interior wall of the trailer and the duct can be disposed between the protective structure and the front interior wall. The duct can therefore extend from the refrigeration unit outlet and down the wall to a low position relative to the floor of the trailer where it can pass through the front wall to the truck. In a particular aspect, the protective structure can also be configured to protect the refrigeration unit. The protective structure can therefore protect and shield refrigeration unit components, ducting, and/or, power cables from damage during the loading of pallet supported loads or other type loads into the trailer and/or from damage due to shifting loads during transit. The protective structure can include plates, bars, beams, wire mesh, or any other suitable structural configuration for providing suitable protection for the duct, duct connections, power cables, reefer components, etc.

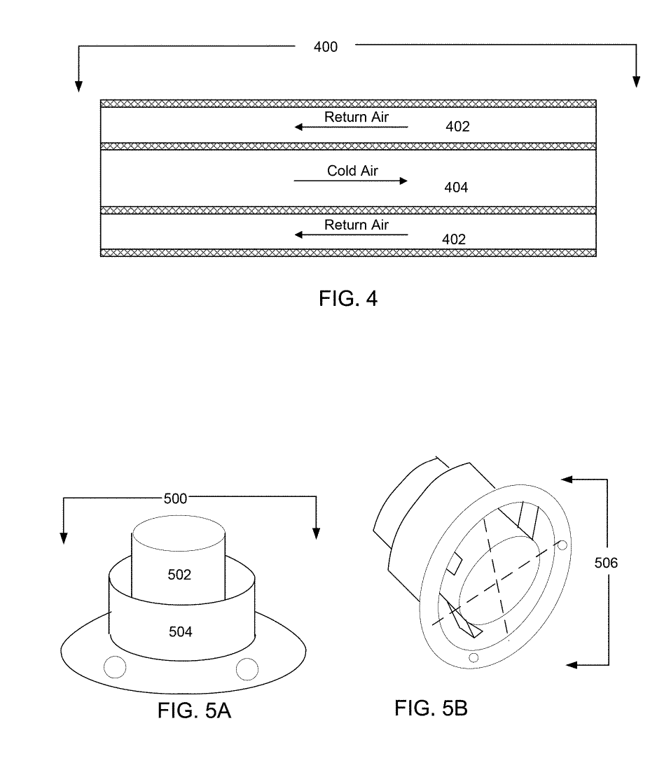

FIG. 4 illustrates the interior of a double wall supply and return air duct 400 of a cold air diverter system in accordance with an example of the present disclosure. For example, the system can include a duct to return air from the cabin to the trailer. This can provide for recirculation of air to balance pressure thereby improving volumetric airflow rate and cooling effectiveness. The return air duct 402 can be associated with at least a portion of the supply duct 404, such as by being disposed about the supply duct. In one aspect, an outer boundary of the supply duct can comprise a circular cross-section and an outer boundary of the return duct can be concentric with the outer boundary of the supply duct. Thus, in one aspect, the return duct can serve to insulate the cold air in the supply duct and/or protect the supply duct from damage. In one example, the outer diameter of the supply duct is 4 inches and the outer diameter of the return air duct is 6 inches. Alternatively, the return air duct and supply air duct can be adjacent non-concentric conduits.

FIGS. 5A and 5B illustrate a double wall supply 500 showing an interior wall 502 and an exterior wall 504 and return air duct end fitting 506 of a cold air diverter system in accordance with an example of the present disclosure. This fitting can be configured to couple the double wall supply and return air duct of FIG. 4 to a wall of the cabin or trailer. In one aspect, quick connectors can be coupled on either end of the combination of the air duct 400 (of FIG. 4) and the double wall supply 500 and the return air duct end fitting 506 on either end of the air duct 400. Completed and engaged hose connections are shown in FIG. 1 (second duct portion 128). In this manner, the air duct 400 can be quickly disconnected by an individual from between a trailer and a tractor.

It should be recognized that the cold air diverter system disclosed herein can be provided as original equipment and/or as part of a kit to retrofit a truck and/or trailer. In order to retrofit the cold air diverter system, the air intake can be oriented adjacent the cold air discharge of the refrigeration unit. However, in some cases, the cold air diverter can be integrated into the refrigeration unit as a secondary cool air outlet.

Also presented herein is a method of cooling a cabin and/or sleeper unit of a tractor trailer. The method can comprise diverting cold air from a refrigerator unit on a refrigeration trailer via an air intake to receive cold air discharged from a cold air outlet on the refrigerator unit to the cabin on the semi-truck via a duct and a fluid moving device, and operating the fluid moving device to pull cold air from the refrigerator unit through the duct and into the cabin. The air intake, ducts, and fluid moving device can be as previously described herein.

FIG. 6 is a schematic illustration of a system 600 for transferring energy from a refrigeration trailer 602 to a truck 604. In some aspects, transferring energy can include providing a coolant loop as a heat exchange medium between the trailer and the truck, and/or providing electrical energy from the trailer to the truck. In one example, the system 600 in configured to transfer cold fluid from the trailer 602 for use in the truck 604 and occupied truck cabin space (e.g. sleeping space). In this aspect, the system 600 can comprise a refrigeration unit 606 (e.g., a reefer) configured to cool a first chamber 608, in a typical manner of known reefers. Notably, the refrigeration unit 606 can have a first heat exchanger 610 configured to cool a fluid F. A second heat exchanger 612 can be disposed in a second chamber 614 and can be in fluid communication with a coolant loop with the first heat exchanger 610. In one aspect, a supply fluid line 616 and a return fluid line 618 fluidly couple the first and second heat exchangers 610 and 612 (see also FIG. 2, showing the first heat exchanger 610 optionally included in a housing of the cold air intake system described therein). In one aspect, a fluid supply quick-connect hose 620 can be coupled between quick-connect ports on the truck 604 and the trailer 602, and similarly, a fluid return quick connect-line hose 622 can be coupled between quick-connect ports. Each “quick-connect hose” can include tractor quick-connectors on either end of each hose. Self-closing disconnects and/or valves can be used to prevent loss of fluid F during disconnection.

The system 600 can comprise a pump 624 fluidly coupled to any portion of the coolant loop for pumping the fluid F through the system to the second chamber 614. Although illustrated as located within the second chamber 608, the pump can be oriented anywhere along a cooling fluid loop (e.g. within the truck 604, as part of the second heat exchanger 626, etc). FIG. 6 shows an example where the pump 624 is within the refrigeration unit 606 and fluidly coupled to the coolant loop, although the pump 624 can be in or around the first or second chambers. The first heat exchanger 610 can be a coil-type heat exchanger coupled to an evaporator and condenser (not shown) in a typical manner to cool fluid F of the coolant loop about the first heat exchanger 610. Said refrigeration unit 606 can be the primary devices used to cool the first chamber 608, or they can be supplemental devices for the sole purpose of cooling the fluid F. Likewise, the second heat exchanger 612 can be a coil-type heat exchanger, such as a fluid-to-air coil exchanger. In the coolant loop, the fluid F is cooled in the heat exchanger 610 and supplied to the second heat exchanger 612 for transferring heat about the second heat exchanger 612 to cool the second chamber 614.

The system 600 can comprise an air moving device 626, such as a pump or fan, to be disposed at least in part in the second chamber 614, such as in a cabin of the truck 604. The air moving device 626 can be operable to convey the cold air from about the second heat exchanger 612 to cool the second chamber 614 (e.g. draw cabin air into the air moving device 626 past the second heat exchanger 626) (see e.g., FIG. 7). Thus, in one aspect, the system can be adapted to cool the cabin 614 of the truck 604 using cold fluid delivered from the heat exchanger 610 to the second heat exchanger 612. Thus, the system can avoid using any air ducting connections between the first chamber 608 or refrigeration unit 606 and the second chamber 614 (e.g. elimination of duct 628.

In another alternative, the system 600 can comprise at least one duct adapted to supply air into the second chamber 614. For instance, duct 628 (between the trailer 606 and the truck 604) can be a single supply duct that supplies cold air from the first chamber 608 to the air moving device 626, or duct 628 can be a dual-duct, such as described with reference to FIG. 4. In this manner, such dual-duct can supply cold air into the air moving device 626 from the first chamber 608, and concurrently return warm air back into the first chamber 608 via duct 628. The duct 628 can have quick-connectors on either end of the duct 628. Thus, the air entering the air moving device 626 can be pre-cooled so that less energy is needed/drawn from the cold fluid delivered to the second heat exchanger 612. This reduces the amount of energy needed to generate and supply cold fluid via the coolant loop. In another aspect, the at least one duct can be a cabin supply duct 632 coupled to the air moving device 626 that draws ambient cabin air into the air moving device 626 (or it can draw air from the outside environment). In any event, an exhaust air duct 634 is provided with the air moving device 626 to supply temperature-controlled air (e.g., cooled or heated air) into the second chamber 614 (e.g. driving and/or sleeping cabin compartments).

In this manner, a heater 636 can also be included in the system 600 to facilitate heating the second chamber 614. For example, the heater 636 can be disposed in or about the truck 604, such as being part of the air moving device 626. The heater 636 can be operable to heat air in or around the air moving device 626 such that the air moving device 626 conveys the heated air into the second chamber 614, as further exemplified below regarding FIG. 7.

In one example, an electrical supply line 638 is coupled to a power source 640 of the refrigeration unit 606 and to the truck 604. The electrical supply line 638 can have quick-connectors on either end for quick coupling and de-coupling between the trailer and the truck. The electrical supply line 638 can facilitate supplying electrical power to the heater 636 and/or the air moving device 626 (e.g., the fan/blower, thermostat, etc.), for example. The power source 640 can be a battery source that is powered by alternator when the truck is operating, or the power source 640 can be an electrical generator fueled by propane or diesel, for instance. In one example, the power source 640 can be the electrical supply on the reefer unit (e.g. diesel generator, reefer alternator, etc). The electrical supply line 638 can also provide electrical power for use of any electronic device 627 associated with the truck 604, such as a TV display, power outlets for personal devices, CB radio, the vehicle stereo, etc. Advantageously, supplying power from the refrigeration unit 606 (via the power source 640) can eliminate or reduce the need to idle the engine of the truck when the driver is at rest, which saves energy costs and minimizes pollution, for example. The power source 640 can supply electrical energy to devices of the refrigeration unit 606 in a typical manner, such as the fans, condensers, evaporators, etc. required to cool the first chamber 608.

FIG. 7 shows one example of a fluid moving device 650 (which can be a fluid moving device of the system 600 of FIG. 6). The fluid moving device 650 can comprise an inlet chamber 652, a blower 656 (having an electric motor), and an air filter 658, all oriented within an enclosure 668. A duct 659 can facilitate the supply of air into the inlet chamber 652 (whether from the fist chamber or second chamber), such as the duct 628 or duct 636 described with reference to FIG. 6 (and ducts of FIG. 4). The fan size, blower capacity and compartments can vary based on the designers and cabin size.

The air filter 658 can be oriented up-stream of the blower 656 and can be used to remove particulates, prevent allergens in the air from entering the cabin, remove odors from the air, and/or to add fragrance to the air. In one embodiment, the air filter can be a carbon filter although fibrous air matte filters can also be used.

The enclosure 668 can also contain a second heat exchanger 660 (such as the second heat exchanger 612 of FIG. 6). Alternatively, the second heat exchanger 660 can be disposed outside of the enclosure 668 (e.g., in-line with supply air). A fluid supply line 662 and a fluid return line 664 can be fluidly coupled to the second heat exchanger 660, which can be a coil heat exchanger or other suitable fluid-to-air heat exchanger to transfer heat about the inlet chamber 652 as air passes about the exchanger. As further discussed regarding FIG. 6, a first heat exchanger 610 can cool fluid F of a coolant loop and have a pump that delivers the cold fluid to the second heat exchanger 660, for example. Optionally, the filter 658 can be replaced with a heat exchanger fluidly coupled to supply and return lines of a coolant loop, which is indicated by fluid lines 661 and 663 that facilitate a coolant loop to heat exchanger 665 (i.e., a coil between the blower 656 and the inlet chamber 652). In any event, the blower 656 draws air from the inlet chamber 652 and across the heat exchanger (660 or 665), which cools the air for delivery through a duct 674 and into the second chamber 614 (FIG. 6), for example.

A heater 669 can be disposed within the enclosure 668 (as shown in phantom lines of FIG. 7), or the heater 669 can be remotely placed outside the housing and coupled to the inlet chamber 652 to supply heated air therein. In either case, the heater 669 can be electrically coupled to a power source of a refrigeration unit of a trailer via an electrical supply line 671, as exemplified regarding FIG. 6. The heater 669 can supply heated air about (or into) the inlet chamber 652 for the blower 658 to draw the heated air through the fluid moving device 650 and out to a truck cabin for heating, for example. The heater 669 can be a resistance coil-type electric heater, or any other suitable heater.

Air flow (cooled or heated air) through the fluid moving device 650 can be unidirectional passing into the inlet chamber 652, through the filter, and then into the blower before entering the second chamber. In another aspect airflow can be multidirectional, allowing air to be removed from the second chamber. The fluid moving device can include a transition feature 674 to convey air from the fluid moving device to an outlet/third ducting 676. In one embodiment, the transition feature can be a transition cube. The transition feature can be adapted to accommodate various ducting sizes, such as a 2″, 4″, 6″ or 8″ round connection. The transition feature can be connected a third duct portion 676 that can extend from the enclosure 668 of the fluid moving device and into or through the second chamber. In another embodiment, the transition feature and third duct portion can be used to directly tie the fluid moving device to the cabin duct work (not shown) existing in the cabin/sleeper unit via a coupling unit (not shown). In yet another embodiment, the third duct portion can be left unsecured within the cabin/sleeper unit along a flexible duct which is movable such that it can place or moved within the cabin.

In one embodiment the enclosure 668 surrounding the fluid moving device 650 can be configured to be disposed inside the cabin or sleeper unit of the truck. In another embodiment, the fluid moving device 650 can be configured in a protective casing that can be disposed exterior of the truck cabin and/or sleeper. The enclosure 668 can also be provided with a fastening feature adapted to secure the enclosure to a surface within or on the truck body. For example, tabs, latches, holes or other features can be used to fasten the enclosure to a floor, wall or other fixed feature of the truck. In one specific embodiment the fastening feature can be a mounting bracket to attach with the fluid moving device.

In one aspect, the enclosure 668 can include an opening to receive ambient air from outside of the first and second chambers. The ambient air can either be used alone or in combination with the cool air from the refrigeration unit to provide a desired temperature inside the second chamber. In one embodiment, the enclosure can include a thermostat or thermostat relay 680 that is operable to allow the user to control the temperature within the second chamber (which can assist to control the heater 669 as well as the volume or temperature of the cold fluid entering the second heat exchanger). The thermostat can be programmable. In another embodiment, the thermostat can be operable by remote. In yet another embodiment, the thermostat can include a shut off valve that shuts off and/or turns on the fluid moving device respectively when the desired temperature range is reached or the temperature in the second chamber falls outside of a desired temperature range. In another aspect, the thermostat can control operation of one or more baffles 682 that can block airflow through the duct. Thus, the baffle can prevent cold or hot air from reaching the cabin due to pressure from inside the trailer. In one aspect, the baffle can be associated with a duct connection and can be configured to automatically close upon separation of the duct connection and to open when the duct is connected.

In one aspect, the fluid moving device 650 can have multiple speeds to provide a suitable volume of airflow to the truck cabin. In another aspect, the fluid moving device 650 can be configured to substantially match the output of the existing native cooling system of the second chamber (as used in combination with the coolant loop of FIG. 6). In one embodiment, this output can be about 250 cubic feet per minute (CFM). In yet other aspects the cooling system can be configured to run at about 100 CFM, about 200 CFM, about 300 CFM, about 400 CFM, about 500 CFM, about 600 CFM, about 700 CFM, about 800 CFM, about 900 CFM, or even about 1,000 CFM. The variable output can be based on the fan or blower size and/or a combination thereof. In another aspect this can be accomplished by using a fluid moving device 650 that has the capacity to provide a suitable volumetric flow rates and accommodate losses due to the ducting and/or connections.

In one aspect, the fluid moving device 650 can include a power source 684 that can be used to power the blower and/or the heater. The power source can be located within the enclosure 668 or exterior to the enclosure. In one aspect, powered components of the system, such as the fluid moving device 650, thermostat 680, and heater 669, can be configured to receive power from the refrigeration unit (such as discussed regarding FIG. 6), which can obviate the need to use truck power or batteries. Suitable electrical cables or wiring can be included to provide a power connection between the refrigeration unit and the fluid moving device (626 or 650) or use existing electrical connections. For example, a jumper between the cabin and the trailer can be used to provide power from the refrigerator unit to the fluid moving device (626 or 650). The jumper can be removably coupled via quick connects or any other suitable removable coupling. In another aspect, the refrigeration unit can also be used to supply power to the cabin or sleeping unit for any other suitable purpose, such as to power appliances, electronics, etc. The system can therefore include any suitable power outlet or coupling feature to facilitate powering auxiliary or miscellaneous items. Accordingly, the refrigeration unit can include an alternator and/or a battery that provides power that can accommodate the refrigeration needs of the trailer, the fluid moving device, and/or any other suitable device that may be powered in the cabin. In other aspects, power can be provided external to the trailer and the cabin to power any suitable device outside the truck and trailer. In another embodiment, the power source can be an electrical outlet. In another embodiment, the power source can be a gas line. In a yet another embodiment, the power source can be a chargeable battery device.

The duct 628 (FIG. 6) and/or the duct (FIG. 7) can comprise some or all of the same features as described above regarding FIGS. 1-5B. The system 600 can also include a protective structure 601 (FIG. 6) configured to protect the fluid lines, duct connections, power cables, etc. from damage inside the first chamber or trailer. For example, the protective structure can provide a bulk head at a distance from a front interior wall of the trailer and the duct can be disposed between the protective structure and the front interior wall. The fluid lines can therefore extend from the refrigeration unit outlet and down the wall to a low position relative to the floor of the trailer where it can pass through the front wall to the truck. In a particular aspect, the protective structure can also be configured to protect the refrigeration unit. The protective structure can therefore protect and shield refrigeration unit components, fluid lines, ducting, and/or, power cables from damage during the loading of pallet supported loads or other type loads into the trailer and/or from damage due to shifting loads during transit. The protective structure can include plates, bars, beams, wire mesh, or any other suitable structural configuration for providing suitable protection for the duct, duct connections, power cables, reefer components, etc.

It should be recognized that the system 600 (and fluid moving device 626 and 650) disclosed herein can be provided as original equipment and/or as part of a kit to retrofit a truck and/or trailer.

Also presented herein is a method of conducting energy from a refrigeration trailer to a truck. The method can comprise cooling a fluid about a first heat exchanger of a refrigeration unit on a refrigeration trailer, and delivering the fluid to a second heat exchanger disposed in or about a cabin of a truck coupleable to the trailer. The method can comprise operating an air moving device to convey cold air from about the second heat exchanger to cool the cabin. The method can comprise delivering power from the refrigeration unit via an electrical supply line to the truck for powering electronic devices associated with the truck.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A system for conducting energy from a refrigeration trailer to a tractor, the system comprising:
a refrigeration unit configured to cool a first chamber and having a first heat exchanger configured to cool a fluid;
a second heat exchanger disposed in a second chamber and being in fluid communication with a coolant loop with the first heat exchanger; and
an air moving device to be disposed at least in part in the second chamber,
wherein the air moving device is operable to convey cold air from about the second heat exchanger to cool the second chamber.

2. The system of claim 1, further comprising a fluid supply line and a fluid return line both in fluid communication with the first and second heat exchangers to define the coolant loop.

3. The system of claim 2, wherein the fluid supply line delivers cold fluid from the first heat exchanger to the second heat exchanger for cooling air about the second chamber.

4. The system of claim 3, wherein the fluid comprises food-safe glycol.

5. The system of claim 3, further comprises a pump operatively coupled to coolant loop to supply cold fluid to the second heat exchanger.

6. The system of claim 1, wherein the first chamber comprises an interior of a refrigeration trailer and the second chamber comprises a cabin of a truck.

7. The system of claim 1, wherein the fluid moving device is configured to receive power from the refrigeration unit.

8. The system of claim 1, wherein the fluid moving device comprises a member selected from the group consisting of a fan, a pump, a blower, or combinations thereof.

9. The system of claim 1, further comprising a heater to be disposed at least in part in the second chamber, wherein the air moving device is operable to convey hot air from about the heater to heat the second chamber.

10. The system of claim 9, wherein the fluid moving device and the heater is configured to receive power from the refrigeration unit.

11. The system of claim 1, further comprising at least one duct operatively coupled to the second chamber to facilitate at least one of supply air and return air about the second chamber.

12. The system of claim 11, wherein the at least one duct extends between the first chamber and the second chamber to at least facilitate supplying cold air from within the first chamber to the second chamber.

13. The system of claim 11, wherein the at least one duct in configured to facilitate supply air and return air from within the second chamber.

14. The system of claim 1, further comprising at least one power electrical supply line coupled to a power source of the refrigeration unit for supplying power to electronic devices associated with the truck.

15. The system of claim 1, further comprising a dual-duct extending between the first chamber and the second chamber, the dual-duct comprising a first duct to supply air from the first chamber to the second chamber, and a second duct to return air from the second chamber to the first chamber.

16. The system of claim 15, further comprising quick-connectors on either end of the dual-duct.

17. The system of claim 1, further comprising an air filter to remove odor from the cold air, and a thermostat to control temperature inside the second chamber.

18. A system for conducting energy from a refrigeration trailer to a truck, the system comprising:
a refrigeration trailer coupled to a truck;
a refrigeration unit coupled to the refrigeration trailer for cooling the refrigeration trailer, the refrigeration unit having a power source; and
an electrical supply line coupled to the power source for supplying power to at least one of an air moving device, a heater, and electronic devices associated with the tractor.

19. A method of conducting energy from a refrigeration trailer to a tractor, the method comprising:
cooling a fluid about a first heat exchanger of a refrigeration unit on a refrigeration trailer;
delivering the fluid to a second heat exchanger disposed in or about a cabin of a truck coupleable to the trailer; and
operating an air moving device to convey cold air from about the second heat exchanger to cool the cabin.

20. The method of claim 19, further comprising delivering power from the refrigeration unit via an electrical supply line to the truck for powering electrical devices associated with the truck.
